(19) United States
(12) Patent Application Publication
(10) Pub. No.: US 2007/0204268 A1
(43) Pub. Date: Aug. 30, 2007

(54) Methods and systems for scheduling processes in a multi-core processor environment

(75) Inventor: Ulrich Drepper, Mountain View, CA (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(73) Assignee: Red. Hat, Inc.

(21) Appl. No.: 11/361,964

(22) Filed: Feb. 27, 2006

(51) Int. Cl. G06F 9/46

(52) U.S. Cl. 718/102

(57) ABSTRACT

Embodiments of the present invention provide efficient scheduling in a multi-core processor environment. In some embodiments, each core is assigned, at most, one execution context. Each execution context may then asynchronously run on its assigned core. If execution context is blocked, then its dedicated core may be suspended or powered down until the execution context resumes operation. The processor core may remain dedicated to a particular thread, and thus, avoid the costly operations of a process or context switch, such as clearing register contents. In other embodiments, execution contexts are partitioned into two groups. The execution contexts may be partitioned based on various factors, such as their relative priority. One group of the execution contexts may be assigned their own dedicated core and allowed to run asynchronously. The other group of execution contexts, such as those with a lower priority, are co-scheduled among the remaining cores by the scheduler of the operating system.

### DESCRIPTION OF THE INVENTION

1. Field of the Invention

The present invention relates generally to scheduling processes/threads, and more particularly, to scheduling for multi-core processors.

2. Background of the Invention

Conventional processors up to these days contain a single powerful core for executing instructions. However, single core processors have become increasingly difficult to design and manufacturer due limits in transistor design, power consumption, and heat generation. Thus, multi-core processors have recently become more common.

A multi-core processor comprises two or more “execution cores,” or computational engines, within a single processor. However, the operating system can handle each of processor's execution cores as a discrete processor, with all the associated execution resources.

By providing multiple execution cores, a multi-core processor can outperform traditional single core microprocessors because it can spread work over multiple execution cores. Thus, a multi-core processor can perform more work within a given clock cycle.

Multi-core processors can execute separate threads of code concurrently. Thus, a multi-core processor can support one thread running from an application and a second thread running from an operating system, or parallel threads running from within a single application. Multimedia and web server applications are especially conducive to thread-level parallelism because many of their operations can run in parallel.

However, the software running on multi-core processor must be written such that it can spread its workload across multiple execution cores. This functionality is called thread-level parallelism or “threading,” and applications and operating systems, such as Linux, Microsoft Windows, and UNIX, that are written to support it are referred to as “threaded” or “multi-threaded.”

Unfortunately, it is difficult to design software that can take full advantage of multi-core processor architectures. Until recently, software developers could simply make relatively small changes to take advantage of the improvements in hardware.

In addition, even if an application is multi-threaded, operating systems must still cope with scheduling the processes across the cores of the processor. Process scheduling is well known as one of the most difficult and complex functions of an operating system. And, multi-core processors only add to the complexity and difficult of process scheduling.

Accordingly, it may be desirable to provide methods and systems that provide efficient scheduling in a multi-core processor environment.

### SUMMARY OF THE INVENTION

In accordance with one feature of the invention, a method is provided for running a number of execution contexts on one or more multi-core processors controlled by an operating system. When the number of cores is greater than or equal to the number of execution contexts, each execution context is assigned to a core of the one or more processors. The execution contexts are then permitted to asynchronously run on their assigned cores.

In accordance with another feature of the invention, a computer system comprises one or more processors having a plurality of processing cores that can each asynchronously execute a process execution context. An operating system may have a kernel that is configured to determine available processing cores in the one or more processors and assign process execution contexts to respective cores that are available. Alternatively, the operating system can be configure to let the user determine the scheduling of execution contexts on specific processing cores.

In accordance with another feature of the invention, a method is provided for running a number of execution contexts on one or more multi-core processor controlled by an operating system. The number of cores may be less than or equal to the number of execution contexts. The execution contexts on the system are partitioned into two groups. A first group of execution contexts is assigned to run asynchronously on respective cores. A second group of execution contexts is assigned among the remaining cores using a scheduler of the operating system.

In accordance with another feature of the invention, a computer system comprises a processor having a plurality of processing cores that can each asynchronously execute a process execution context. An operating system may have a kernel that is configured to partition the number of execution contexts on the system into two groups, assigning a first group of execution contexts to run asynchronously on assigned cores, and schedule a second group of execution contexts among the remaining cores using a scheduler of the operating system.

Additional features of the present invention will be set forth in part in the description which follows, and in part will be obvious from the description, or may be learned by practice of the invention. It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1 illustrates a computer system that is consistent with embodiments of the present invention;

FIG. 2 illustrates a relationship between the memory and the operating system of the computer system shown in FIG. 1;

FIG. 3 illustrates one embodiment of scheduling cores in a multi-core processor;

FIG. 4 illustrates another embodiment of scheduling cores in a multi-core processor;

FIG. 5 illustrates an exemplary process flow for assigning each processor core at most one execution context; and

FIG. 6 illustrates an exemplary process flow for assigning execution contexts across multiple processing cores.

### DESCRIPTION OF THE EMBODIMENTS

Embodiments of the present invention provide methods and systems that provide efficient execution in a multi-core processor environment by avoiding ongoing scheduling for some of the execution contexts. In some embodiments, each core is assigned at most, one execution context. Each execution context may then asynchronously run on its assigned core. If execution context is blocked, then its dedicated core may be suspended or powered down until the execution context resumes operation. The processor core remains dedicated to a particular execution context, and thus, avoid the costly operations of a process or context switch, such as swapping register contents.

In other embodiments, execution contexts are partitioned into groups. The execution contexts may be partitioned based on various factors, such as their relative priority. For example, execution contexts associated with real-time applications or multi-media applications may be given a higher priority than an operating system execution context or an execution context for a background process. The first group of the execution contexts may be assigned their own dedicated core and allowed to run asynchronously. Meanwhile, the second group of execution contexts are share the remaining cores and are scheduled by the scheduler of the operating system as in traditional operating systems.

Reference will now be made in detail to exemplary embodiments of the invention, which are illustrated in the accompanying drawings. Wherever possible, the same reference numbers will be used throughout the drawings to refer to the same or like parts.

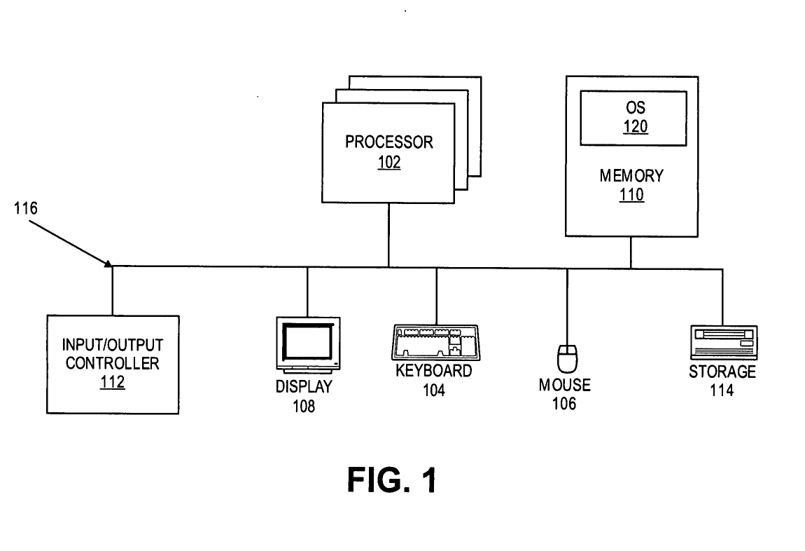

FIG. 1 illustrates a computer system 100 that is consistent with embodiments of the present invention. In general, embodiments of the present invention may be implemented in various computer systems, such as a personal computer, server, workstation, an embedded system, and the like. However, for purposes of explanation, system 100 is shown as a general purpose computer that is well known to those skilled in the art. Examples of the components that may be included in system 100 will now be described.

As shown, computer system 100 may include one or more processors 102, a keyboard 104, a pointing device 106 (e.g., mouse, or the like), a display 108, a main memory 110, an input/output controller 112, and a storage device 114. System 100 may also be provided with additional input/output devices, such as a printer (not shown). The various components of the system 100 communicate through a system bus 116 or similar architecture. In addition, computer system 100 may include an operating system (OS) 120 that resides in memory 110 during operation.

Processor 102 is a multi-core processor, and thus, comprises two or more execution cores or engines. An execution core is any part of a processor that performs the operations and calculations called for by a running process. An execution core may have its own internal control sequence unit, a set of registers to describe the state of the execution, and other internal units to implement its functions. For example, an execution core may have its own bus manager and memory interface, and other components to perform calculations.

In order to coordinate the operation of its processing cores, processor 102 may provide various features. For example, processor 102 may provide various synchronization primitives, such as a semaphore or machine instruction, that coordinate the operation of its cores. Some processors, like those from Intel have hardware support for context switches and synchronization. Alternatively, synchronization may be performed at the software level using services of OS 120 and sharing data in memory 110.

Such processors are well known to those skilled in the art. For example, manufacturers such as IBM, Advanced Micro Devices, Sun Microsystems, and Intel, offer several multi-core processors that may include a range of numbers of cores. Indeed, processors of up to 96 cores, such as those from ClearSpeed, are known to those skilled in the art. Embodiments of the present invention are applicable to any number of processing cores in system 100.

In addition, one skilled in the art will recognize that system 100 may comprise a number of processors 102. For example, system 100 may comprise multiple copies of the same processor. Alternatively, system 100 may comprise a heterogeneous mix of processors. For example, system 100 may use one processor as a primary processor and other processors as co-processors. Embodiments of the present invention may comprise a wide variety of mixes. Thus, system 100 may comprise virtually any number of execution cores across processors 102.

As to keyboard 104, pointing device 106, and display 108, these components may be implemented using components that are well known to those skilled in the art. One skilled in the art will also recognize that other components and peripherals may be included in system 100.

Main memory 110 serves as a primary storage area of computer system 100 and hold data that are actively being used by applications and processes running on processor 102. Memory 110 may be implemented as a random access memory or other form of memory, which are well known to those skilled in the art.

OS 120 is an integrated collection of routines and programs that are responsible for the direct control and management of hardware in system 100 and system operations. Additionally, OS 120 provides a foundation upon which to run application software. For example, OS 120 may perform services, such as resource allocation, scheduling, input/output control, and memory management. OS 120 may be predominantly software, but may also comprise partial or complete hardware implementations and firmware. Well known examples of operating systems that are consistent with the principles of the present invention include Linux, Mac OS by Apple Computer, Sun Solaris by Sun Microsystems, and Windows by Microsoft Corporation.

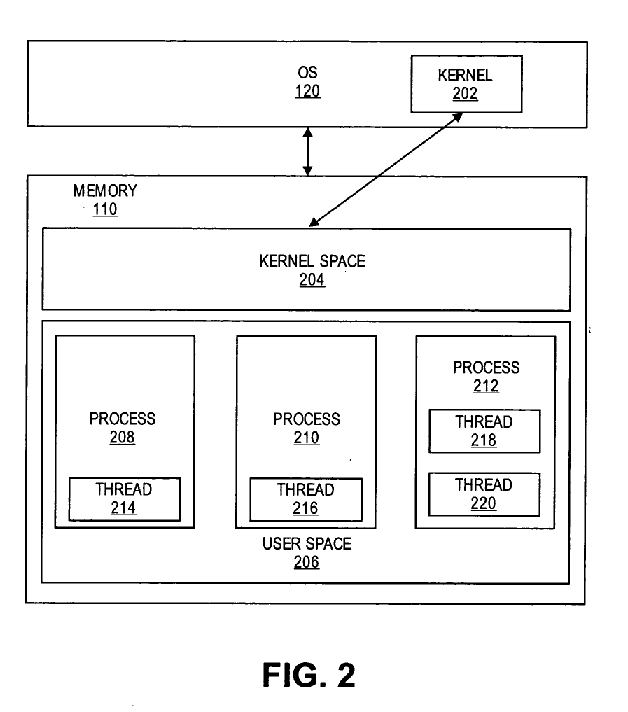

Reference will now be made to FIG. 2 to illustrate the general relationship between memory 110 and OS 120. In order to run a program or application, OS 120 may create a process for running that program or application. As shown, OS 120 may support processes 208, 210, and 212 running of memory 110. Accordingly, at least some portion of processes 208, 210, and 212 are shown occupying user space 206 in memory 110. One skilled in the art will recognize that data for processes 208, 210, and 212 may also be swapped in/out of memory 110 to/from other storage locations, such as storage 114.

Processes 208, 210, and 212 conceptually represent running instances of a program including variables and other state information. In general, processes 208, 210, and 212 are independent of each other, have separate address spaces, and may interact with each other using well known inter-process communications services provided by OS 120.

Each of processes 208, 210, and 212 may consist of one or more execution contexts. An execution context relates to the operations for performing one or more tasks of a process. Execution contexts are also known to those skilled in the art as “threads” of execution, fibers, etc. Typically, multiple threads of a single process share the same address space, and other resources of system 100. During operation, an execution context may be waiting for a resource, or for an event. For example, an execution context for a graphical user interface process may be waiting for input from a user. In these instances, the execution context is said to be “blocked.” The execution context may then be wakened when operations are supposed to be resumed.

OS 120 may further comprise a kernel 202. Kernel 202 is the core of OS 120 and assists in providing access to memory 110 or devices like storage 114 and to the processes running on computer system 100, including the scheduling of processes 208, 210, and 212. Kernel 202 may also provide low level services, such as thread management, address space management, direct memory access, interprocess communication, basic runtime libraries, and the like.

In some embodiments, kernel 202 may directly access or reside in a kernel space 204 of memory 110 that is reserved for the use of kernel 202, device drivers supported by kernel 202, and any kernel extensions.

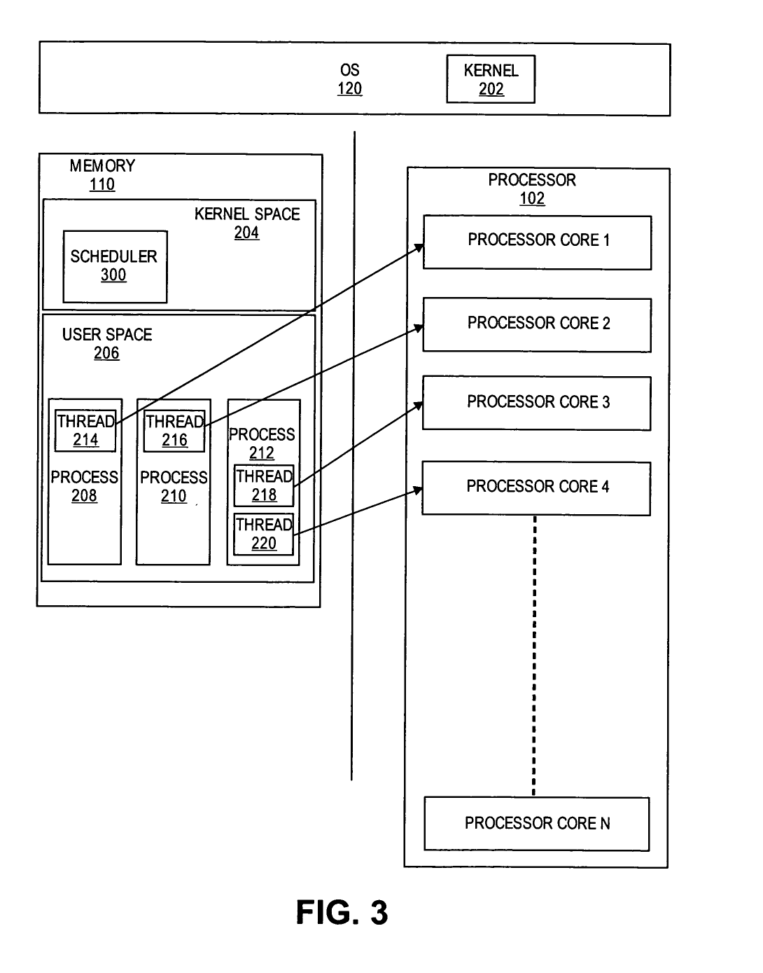

FIG. 3 illustrates one embodiment of scheduling cores in a multi-core processor. For purposes of illustration, FIG. 3 depicts one processor, i.e., processor 102, having n processor cores. However, one skilled in the art will recognize that embodiments of the present invention may apply to multiple cores across multiple processors. As shown, kernel 202 is running a scheduler 300 in kernel space 204 of memory 110. In addition, processes 208, 210, and 212 are running in user space 206 of memory 110.

Scheduler 300 is the component of OS 120 that determines which process should be run, when and where. In the embodiment shown in FIG. 3, scheduler 300 is configured to schedule each execution context its own core. Hence, each core is assigned, at most, one execution context. For example, process 208 may include an execution context 214, which is assigned to processor core 1 of processor 102. Correspondingly, process 210 may include an execution context 216 that is assigned to processor core 2 and processor 212 may comprise execution contexts 218 and 220 that are assigned processor cores 3 and 4, respectively.

Due to its simplicity, this type of scheduling policy may be advantageous where system 100 comprises enough processing cores that exceed the number of running processes and execution contexts. Alternatively, this type of scheduling policy may be advantageous where system 100 is an embedded system, such as a music player, mobile phone, and the like.

In addition, the scheduling policy illustrated in FIG. 3 may avoid the overhead and costs of context switching. As is well known to those skilled in the art, context switching is usually computationally intensive and much of the design of most operating systems is to optimize the use of context switches. In contrast, embodiments of the present invention allow OS 120 to utilize a much simpler scheduling policy, and thus, maximize its performance.

In order to avoid context switching, each processing core is assigned exclusively to, at most, one execution context. When an execution context is blocked, the processing core assigned to that context is suspended (rather than forced to undergo a context switch). In some embodiments, when suspended, the execution core may be powered down or delayed in its execution in order to conserve power and accordingly produce less heat. Of course, the execution cores may be managed according to various criteria to maximize the performance of system 100.

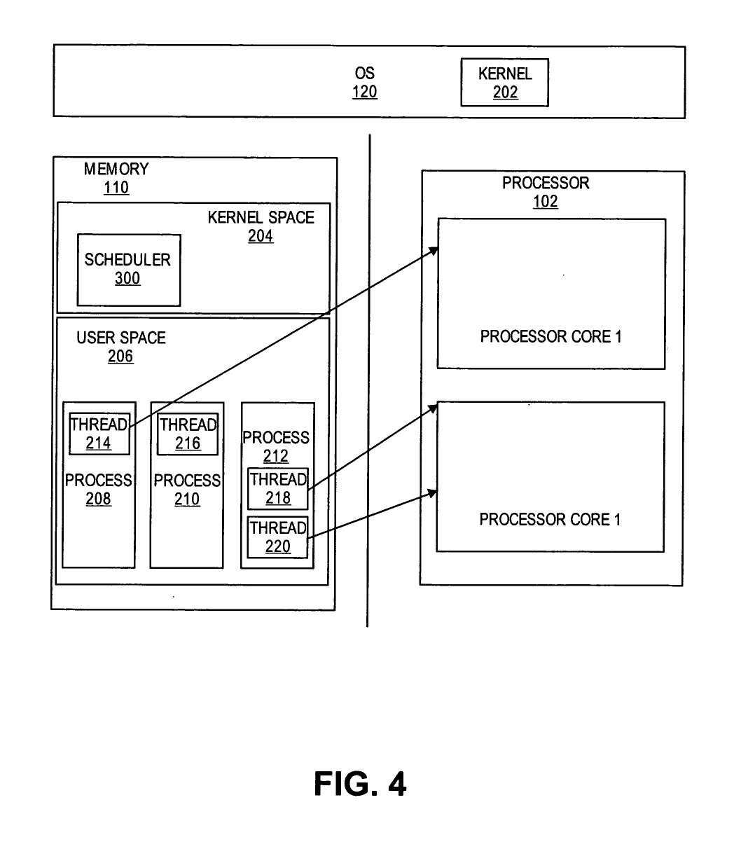

FIG. 4 illustrates another embodiment of scheduling cores in a multi-core processor. One skilled in the art will recognize that some implementations of system 100 may relate to environments where the number of running processes exceed the number of processing cores, such as a personal computer or a machine with relatively few processing cores. For purposes of illustration, FIG. 4 depicts one processor, i.e., processor 102, having two processor cores. In this embodiment, scheduler 300 is configured to partition the execution contexts into groups. For example, scheduler 300 may partition execution context 214 into one group and execution contexts 216, 218, and 220 into another group.

Scheduler 300 may then assign execution context 214 its own processor core, i.e., processor core 1. Scheduler 300 may decide which execution contexts are assigned their own dedicated core based on a variety of criteria. For example, scheduler 300 may partition execution contexts in two groups based on a static or dynamic priority. One skilled in the art will recognize that various types of execution contexts may be well suited for assignment to an exclusive core, such as those involving fine grained tasks or computational intensive tasks.

In addition, scheduler 300 may manage the available execution cores in various ways. For example, some of the execution cores may be statically assigned to those execution contexts that are assigned an exclusive core. Alternatively, scheduler 300 may dynamically determine which cores are exclusively assigned to execution contexts and those cores in which execution contexts are co-scheduled, e.g., time shared.

For those execution contexts that are not assigned an exclusive core, scheduler 300 may co-schedule these contexts. For example, scheduler 300 in FIG. 4 is shown assigning execution contexts 216, 218, and 220 onto the remaining processor cores, i.e., processor core 2 in FIG. 4. Scheduler 300 may use conventional scheduling policies to co-schedule execution contexts 216, 218, and 220. For example, scheduling 300 may use well known time sharing algorithms, such as those employed by Linux and UNIX operating systems. Other scheduling algorithms, such as round robin scheduling and hierarchical scheduling, may also be employed in various embodiments. In addition, scheduler 300 can distribute the execution contexts to all available processing cores in all of the plurality of processors in the system 100. One skilled in the art will recognize that execution contexts may be better suited for co-scheduling, such as those involving user interaction or I/O intensive operations.

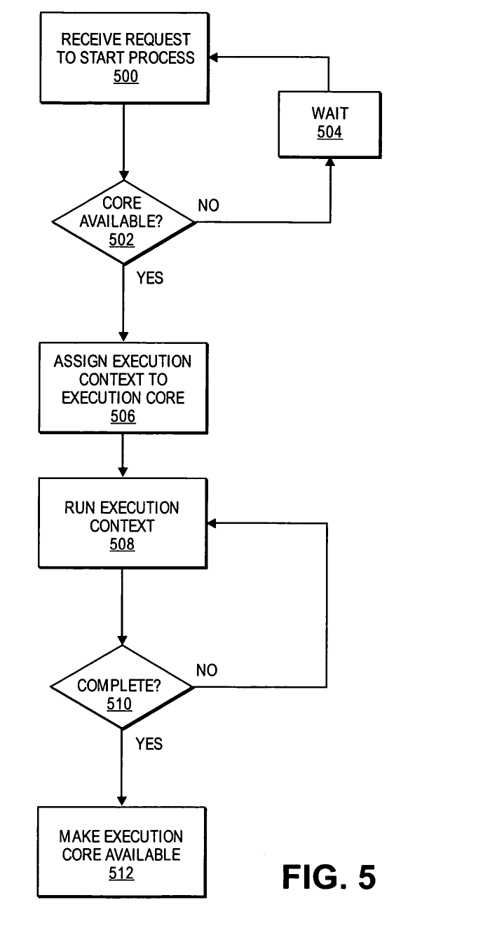

FIG. 5 illustrates an exemplary process flow for assigning each processor core at most one execution context. In stage 500, OS 120 receives a request to start a process, such as process 208, 210, or 212. In stage 502, OS 120 passes the request to kernel 202. In response, scheduler 300 is invoked and determines if any cores of processor 102 are available.

If no cores are available, then processing may flow to stage 504 where OS 120 may hold the request and wait until a core becomes available. Alternatively, OS 120 may deny the request. Other types of responses are well known to those skilled in the art.

In stage 506, scheduler 300 has found one or more available execution cores and exclusively assigns the execution context to one of the available cores. As noted above, examples of exclusive assignment are illustrated in FIG. 3.

In stage 508, processor 102 allows the execution contexts to asynchronously run on their respective execution cores. Conceivably, one or more execution contexts running on processor 102 may require synchronization. In these instances, the execution contexts may be synchronized using hardware or software operations. For example, processor 102 may provide various synchronization primitives to synchronize execution contexts by suspending execution until a specific condition is met. Alternatively, OS 120 may provide various services that synchronize execution contexts that have been assigned their own execution core.

In stage 510, processor 102 determines whether an execution context has completed its operation. If an execution context has not completed, i.e., it's still running, and then processing may repeat at stage 508. However, if an execution context has completed, then in stage 512 processor 102 may notify scheduler 300. In response, scheduler 300 may terminate or destroy the completed execution context and make its respective execution core available for reassignment to another execution context. Alternatively, upon an execution core completing its current execution context, processor 102 may automatically free that execution core and notify scheduler 300. Other sequences of operation may depend upon the specific implementations of processor 102 or OS 120.

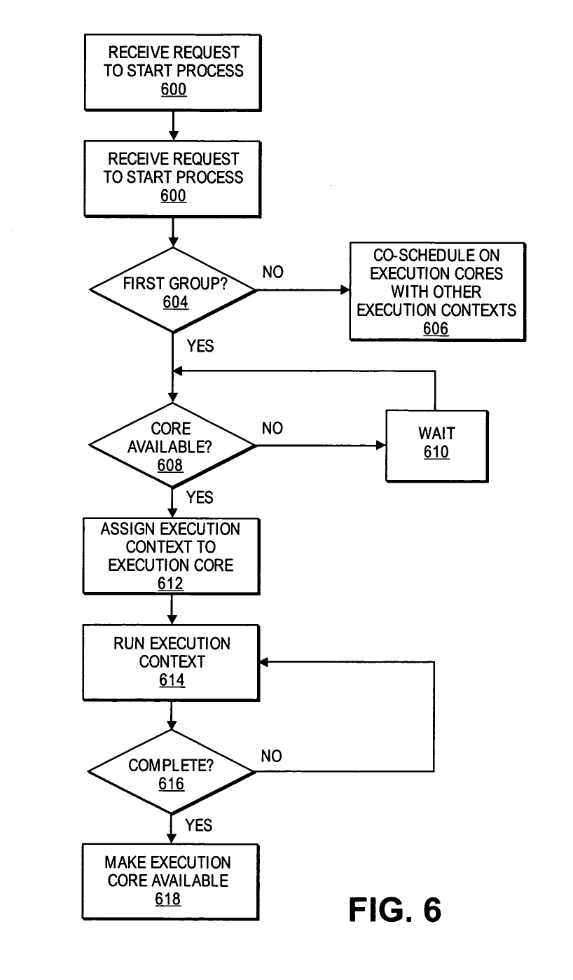

FIG. 6 illustrates an exemplary process flow for assigning execution contexts across multiple processing cores. In stage 600, OS 120 receives a request to start a process, such as process 208, 210, or 212. In stage 602, OS 120 passes the request to kernel 202. In response, scheduler 300 is invoked and assigns the execution context for the requested process to one of two groups. For example, the first group may consist of high priority execution contexts that are best suited for an exclusive execution core. Meanwhile, the second group may consist of lower priority execution contexts or other types of executions contexts that are best suited for co-scheduling on a shared execution core. The scheduler 300 may dynamically reassign execution contexts from the second group to the first group if the scheduling parameters change.

In stage 604, if the execution context is assigned to the first group for exclusive assignment, then that execution context may be assigned its own execution core in a manner similar described above with reference to FIG. 5. However, if the execution context is not assigned to the first group, then, in stage 606, OS 120 may co-schedule the execution context on one or more shared execution cores. As noted above, an example of co-scheduled execution contexts on a shared execution core is shown in FIG. 4.

For those execution contexts in the first group for exclusive assignment, in stage 608, scheduler 300 determines if any cores of processor 102 are available for exclusive assignment to that execution context. If no cores are available, then processing may flow to stage 610 where OS 120 may hold the request and wait until a core becomes available. Alternatively, OS 120 may deny the request or overflow the request to shared execution cores such that the execution context is co-scheduled with other execution contexts. Other types of responses are well known to those skilled in the art.

In stage 612, scheduler 300 has found one or more available execution cores and exclusively assigns the execution context to one of the available cores. As noted above, examples of exclusive assignment are illustrated in FIG. 3.

In stage 614, processor 102 allows the execution contexts to asynchronously run on their respective execution cores. Conceivably, one or more execution contexts running on processor 102 may require synchronization. In these instances, the execution contexts may be synchronized using hardware or software operations. For example, processor 102 may provide various synchronization primitives to synchronize execution contexts. Alternatively, OS 120 may provide various services that synchronize execution contexts that have been assigned their own execution core.

In stage 616, processor 102 determines whether an execution context has completed its operation. If an execution context has not completed, i.e., it's still running, and then processing may repeat at stage 614.

However, if an execution context has completed, then in stage 618 processor 102 may notify scheduler 300. In response, scheduler 300 may make that execution core available for reassignment to another execution context. Alternatively, upon an execution core completing its current execution context, processor 102 may automatically free that execution core and notify scheduler 300. Other sequences of operation may depend upon the specific implementations of processor 102 or OS 120.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of running a number of execution contexts on one or more multi-core processors through an operating system, wherein the number of cores is greater than or equal to the number of execution contexts, said method comprising:
assigning each execution context to a core of the one or more processors; and
asynchronously running the execution contexts on their assigned cores.

2. The method of claim 1, further comprising:
identifying when a plurality of execution contexts require synchronization; and
synchronizing the plurality of execution contexts using instructions provided by the processor based on when the plurality of execution contexts require synchronization.

3. The method of claim 1, further comprising:
identifying when a plurality of execution contexts require synchronization; and
synchronizing the plurality of execution contexts using a service of the operating system based on when the plurality of execution contexts require synchronization.

4. The method of claim 1, wherein assigning each execution context to the core of the one or more processors comprises assigning each of the cores one execution context at most.

5. The method of claim 4, further comprising:
determining when the one execution context is blocked;
suspending operation of the core assigned to the one execution context; and
preventing the core assigned to the at least level execution context from being switched to another execution context.

6. The method of claim 5, wherein suspending operation of the core comprises suspending the core based on a service of the operating system.

7. The method of claim 5, wherein suspending operation of the core comprises suspending the core based on an instruction provided from the processor.

8. The method of claim 5, wherein suspending the operation of the core assigned to the one execution context is performed based on an instruction provided from the processor.

9. The method of claim 7, wherein suspending operation of the core assigned to the at least one execution context comprises powering down the core assigned to the at least one execution context.

10. The method of claim 1, further comprising:
determining when the execution context has completed; and
allowing the execution core assigned the completed execution context to be reassigned to another execution context.

11. An apparatus configured to perform the method of claim 1.

12. A computer readable medium comprising computer executable instructions for performing the method of claim 1.

13. A computer system, comprising:
at least one processor having a plurality of processing cores that can each asynchronously execute an execution context; and
an operating system having a kernel that is configured to determine available processing cores and assign execution contexts to respective cores that are available.

14. The computer system of claim 13, wherein the operating system is configured to identify when a plurality of execution contexts require synchronization and the at least one processor provides an instruction that synchronizes the plurality of execution contexts based on when the plurality of execution contexts require synchronization.

15. The computer system of claim 13, wherein the operating system is configured to identify when a plurality of execution contexts require synchronization for an application and provide a service that synchronizes the plurality of execution contexts based on when the plurality of execution contexts require synchronization.

16. The computer system of claim 13, wherein the operating system is configured to assign each of the cores at most one execution context.

17. The computer system of claim 16, wherein the operating system is configured to determine when the one execution context is blocked, and the at least one processor is configured to suspend operation of the core assigned to the at least one execution context, while maintaining the assignment of the core to that one execution context.

18. The computer system of claim 16, wherein the operating system is configured to determine when the one execution context is blocked due to a request for synchronization and suspend the operation of that core.

19. The computer system of claim 16, wherein the at least one processor is configured to determine when the one execution context is blocked due to a synchronization primitive and suspend the operation of the core.

20. A method of running a number of execution contexts on one or more multi-core processor through an operating system, wherein the number of cores is less than or equal to the number of execution contexts, said method comprising:
partitioning the number of execution contexts on the system into two groups;
assigning a first group of execution contexts to run asynchronously on respective cores; and
scheduling a second group of execution contexts among the remaining cores using a scheduler of the operating system.

21. The method of claim 20, further comprising:
identifying when a plurality of execution contexts in the first group require synchronization; and
synchronizing the plurality of execution contexts using an instruction provided from the processor based on when the plurality of execution contexts require synchronization.

22. The method of claim 20, further comprising:
identifying when a plurality of execution contexts in the first group require synchronization; and
synchronizing the plurality of execution contexts using a service of the operating system based on when the plurality of execution contexts require synchronization.

23. The method of claim 20, wherein assigning the first group of execution contexts to respective cores comprises assigning the respective cores, at most, one execution context.

24. The method of claim 23, further comprising:
determining when the one execution context is blocked;
suspending operation of the core assigned to the one execution context; and
preventing the core from being reassigned to another execution context.

25. The method of claim 23, further comprising:
determining when the one execution context is blocked due to a synchronization primitive; and
suspending the operation of the core assigned to the one execution context based on a request for synchronization.

26. The method of claim 25, wherein suspending the operation of the core assigned to the one execution context is performed based on an instruction from the processor.

27. The method of claim 23, wherein suspending operation of the core assigned to the one execution context comprises powering down the core assigned to the one execution context.

28. An apparatus configured to perform the method of claim 20.

29. A computer readable medium comprising computer executable instructions for performing the method of claim 20.

30. A computer system, comprising:
a processor having a plurality of processing cores that can each asynchronously execute an execution context; and
an operating system having a kernel that is configured to partition the number of execution contexts on the system into groups, assigning a first group of execution contexts to run asynchronously on respective cores, and scheduling a second group of execution contexts among the remaining cores using a scheduler of the operating system.

31. The computer system of claim 30, wherein the operating system is configured to identify when one or more of the execution contexts in the first group require synchronization with any other execution context and the processor comprises a component that synchronizes the one or more execution contexts when the synchronization is requested.

32. The computer system of claim 30, wherein the operating system is configured to identify when one or more of the execution contexts in the first group require synchronization for an application and provide a service that synchronizes the one or more of the execution contexts.

33. The computer system of claim 30, wherein the operating system is configured to exclusively assign one execution context in the first group of execution contexts to one of the cores.

34. The computer system of claim 33, wherein the operating system is configured to determine when the at least one execution context in the first group is blocked, and the processor is configured to suspend operation of the core assigned to the one execution context, while maintaining the assignment of the core to the one execution context.

35. The computer system of claim 33, wherein the operating system is configured to determine when the one execution context in the first group is blocked due to a synchronization primitive and suspend the operation of that core.

36. The computer system of claim 33, wherein the processor is configured to determine when the one execution context in the first group is blocked due to a request for synchronization and suspend operation of that core.

37. The computer system of claim 33, wherein the processor is configured to suspend operation of the core assigned to the one execution context by powering down the core.

38. The computer system of claim 30, wherein the processor is configured to allow its processing cores assigned to execution contexts in the first group to respond to asynchronous events and select a code path associated with the asynchronous event.
